(19) United States
(12) Patent Application Publication
(10) Pub. No.: US 2025/0190872 A1
(43) Pub. Date: Jun. 12, 2025

(54) FEEDBACK BASED IMPROVEMENT TO PRIVATE GENERATIVE ARTIFICIAL INTELLIGENCE MODEL

(71) Applicant: Crystal Computing Corp., Menlo Park, CA (US)

(72) Inventor: Cole L. Kissane, Palo Alto, CA (US)

(21) Appl. No.: 18/974,651

(22) Filed: Dec. 9, 2024

Related U.S. Application Data
(60) Provisional application No. 63/609,284, filed on Dec. 12, 2023.

(51) Int. Cl. G06N 20/00

(52) U.S. Cl. CPC G06N 20/00

(57) ABSTRACT

Feedback based improvement of a private generative artificial intelligence model is disclosed. In various embodiments, feedback associated with content generated by artificial intelligence in response to a prompt is received. A private model with which the feedback is associated is determined. The feedback is used to update a reward model associated with the private model

### CROSS REFERENCE TO OTHER APPLICATIONS

This application claims priority to U.S. Provisional Patent Application No. 63/609,284 entitled FEEDBACK BASED IMPROVEMENT TO PRIVATE GENERATIVE ARTIFICIAL INTELLIGENCE MODEL filed Dec. 12, 2023 which is incorporated herein by reference for all purposes.

### BACKGROUND OF THE INVENTION

Generative artificial intelligence systems using large language models trained on a corpus of data have been used to generate reasonably compelling text and other content (e.g., images) in response to input prompts. Techniques, such as Reinforcement Learning from Human Feedback (RLHF), have been developed to improve (e.g., “fine tune”) a large language model based on feedback from human users. Human users rate content generated using the large language model and the feedback is used to fine tune the model.

Typically, the owner of the large language model and/or associated generative AI system has provided the user interface (or other interface) to solicit and receive human feedback on result generated by a generative AI system. As a result, the feedback typically has been used to improve the generative AI system's foundational large language model, to the benefit of the owner of the generative AI system, as opposed to the developer/owner of an application that a human user may have interacted with the generate the results.

### BRIEF DESCRIPTION OF THE DRAWINGS

Various embodiments of the invention are disclosed in the following detailed description and the accompanying drawings.

FIG. 1 illustrates an embodiment of a generative AI system and environment.

FIG. 2A illustrates a set of domain (e.g., subject matter) specific models and/or proprietary models and sub-models associated with a foundational generative AI model, such as a foundational large language or image model.

FIG. 2B illustrates an embodiment of a process and workflow to enable feedback on AI-generated content to be used to improve a private model, e.g., to the benefit of the entity entitled to exclusively use the private model.

FIG. 2C is a diagram illustrating the creation and maintenance, in various embodiments, of a proprietary generative AI model as disclosed herein.

FIG. 3A is a flow diagram illustrating an embodiment of a process to respond to a generative AI system prompt received from a user associated with a proprietary model.

FIG. 3B is a flow diagram illustrating an embodiment of a process to receive and use feedback provided to a generative AI system in response to content generated using a proprietary model.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to enable application developers/owners and others having a proprietary interest in a proprietary generative AI model to benefit more directly and exclusively from the feedback provided on generative AI results provided in connection with use of an application developed/owned by the application developers/owners, for example.

As used herein, the terms “proprietary generative AI model”, “proprietary model”, and “private model” are used interchangeably to refer to a model that is based, directly or indirectly, at least in part on a foundational (base) generative AI model to which a body of users (e.g., the general public, all customers or tenants of a generative AI system or service, etc.) have access, but to which only a subset of users comprising the body of users has access, e.g., by virtue of having a proprietary interest in the proprietary (private) model and/or being a user of an application or service the provider of which has a proprietary (or other exclusive) interest in the proprietary model.

In various embodiments, an application may be associated with a proprietary generative AI model owned by the developer/owner of the application. The proprietary model may be derived from a foundational model of a generative AI system/platform but may be optimized or otherwise fine-tuned to perform specific generative AI tasks in a specific subject matter domain, for example. Further, the proprietary model may be improved, using techniques disclosed herein, based on interactions with the proprietary model, e.g., by users of the application.

In various embodiments, the prompts users have used to generate content using a proprietary model, and explicit or implicit feedback from users (or other sources) reflecting on the quality, desirability, appropriateness, accuracy, etc., of generated content, etc. may be used to fine-tune a proprietary or other private model.

In some embodiments, techniques disclosed herein are used to enable human feedback from users of a proprietary user-facing application to be used to improve a proprietary model associated with the user-facing application, without the application developer of the user-facing application having to create infrastructure to solicit and receive user feedback and/or to use such feedback to improve the proprietary model.

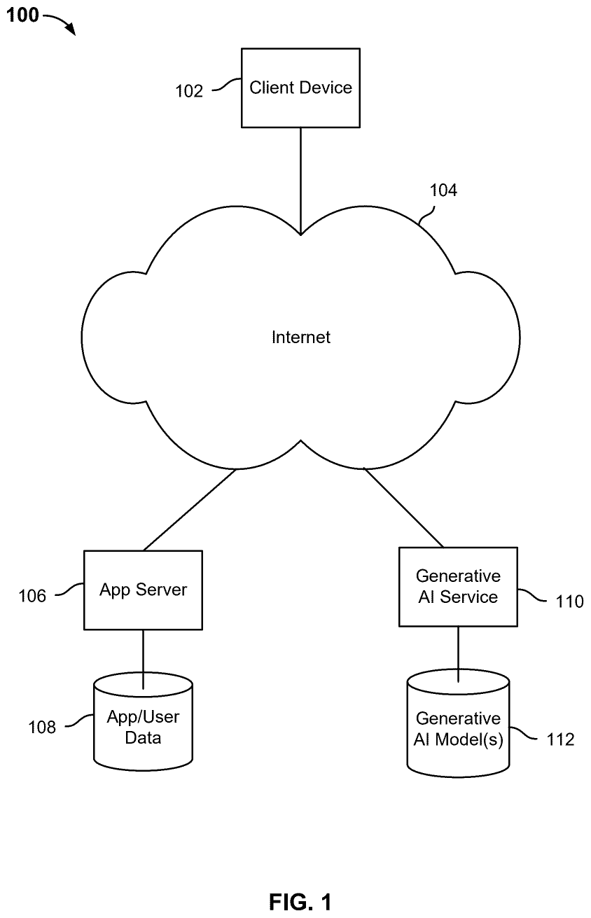

FIG. 1 illustrates an embodiment of a generative AI system and environment. In the example shown, system and environment 100 includes (optionally) a client device 102 connected via the Internet 104 to an application server 106. Application server 106 uses application/user data 108 to provide access to an application to a user of client device 102, as well as other users of other client devices. In some embodiments, techniques disclosed herein may be used by or in connection with an application running on application server 106 that does not (necessarily) include or require any client device. In various embodiments, application server 106 may be configured to make an API or other call to a generative AI service 110, which uses one or more generative AI models 112, such as a large language model, to generate and return a response to application server 106.

In various embodiments, calls made by application server 106 to generative AI service 110 may be processed using a model that is at least in part a proprietary model associated exclusively with an owner/developer of the application with which the application server 106 is associated. The proprietary model may be owned by an owner/provider of the generative AI service 110 but may reflect and embody fine-tuning or other learning/feedback received in connection with use of the application running on application server 106 and may be reserved for the private use of an owner/developer of the application running on application server 106.

In various embodiments, generative AI service 110 uses techniques disclosed herein to enable users of application server 106, e.g., a user associated with client device 102, to provide feedback on the quality, appropriateness, desirability, suitability, fit, etc. of generative AI-produced content included in a response received by the user from the application server 106 based on content obtained by application server 106 from generative AI service 110. The user feedback may be used, as disclosed herein, to fine tune or otherwise improve (optionally only) a proprietary large language or other generative AI model and/or a proprietary portion or aspect of a large language or other generative AI model associated with the application server 106.

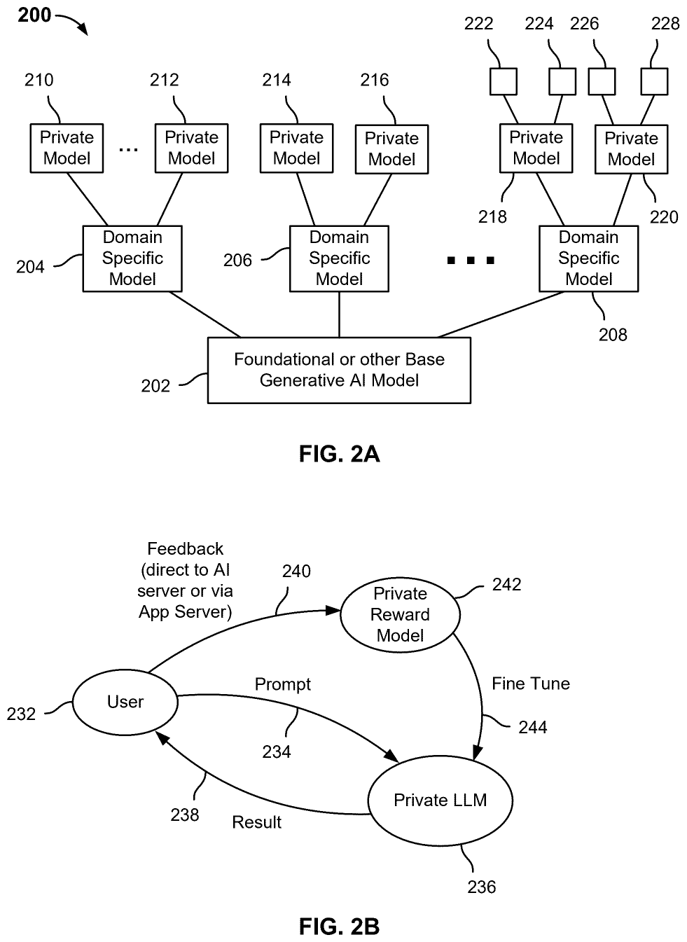

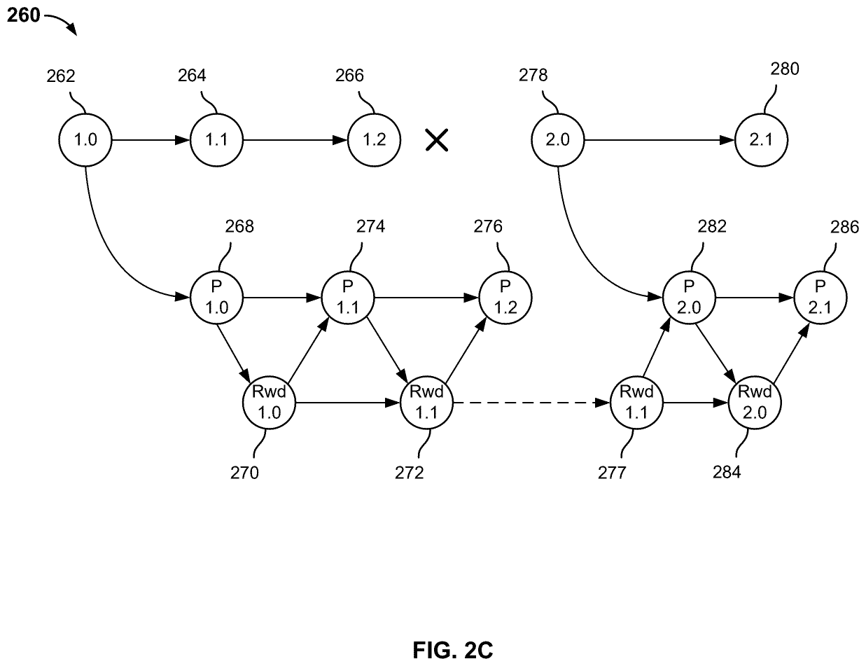

FIG. 2A illustrates a set of domain (e.g., subject matter) specific models and/or proprietary models and sub-models associated with a foundational generative AI model, such as a foundational large language or image model. In the example shown, the set of models 200 includes a foundational large language model 202 based on which a plurality of domain specific models, represented in FIG. 2A by models 204, 206, and 208, have been derived. Foundational model 202 may have been created, for example, via unsupervised training using a large corpus of text-based and/or other (e.g., image) content. Domain specific models, e.g., models 204, 206, and 208, may have been derived from Foundational model 202, e.g., by further training the models based on domain-specific information and/or based on feedback by domain experts. In the example shown, for each of at least a subset of the domain specific models, e.g., models 204, 206, and 208, a further and potentially even more specific set of proprietary models, e.g., private models 210, 212, 214, 216, 218, and 220, have been derived. Each proprietary model may be owned by the generative AI service provider but reserved for the exclusive, private use of an associated application owner/developer.

In the example shown in FIG. 2A, the owners of the exclusive right to use some proprietary models have further derived even more specific models, such as models 222, 224, 226, and 228. For example, model 222 may be derived using customer or other specific data associated with a particular customer or set of customers of the owner of proprietary model 218.

FIG. 2B illustrates an embodiment of a process and workflow to enable feedback on AI-generated content to be used to improve a private model, e.g., to the benefit of the entity entitled to exclusively use the private model. In the example shown, user 232 submits a prompt 234 to a generative AI system configured to use a proprietary model 236 to generate and return a result 238. User 232 may be a human user, an application, or an artificial intelligence-based entity. The result includes, in various embodiments, an AI-generated content generated in response to the prompt 234 using the proprietary model 236 and an identifier associated with the result 238.

Feedback 240 on the quality of the result 238 is sent to the generative AI system, either directly or via/by the application server. In some embodiments, the user 232 uses a feedback widget or other interface provided by the generative AI system to cause feedback 240 to be sent to the generative AI system. In various embodiments, feedback 240 may be generated by one or more users or sources other than or in addition to user 232, such as a representation of the collective judgment of a group of users to whom the same AI generated content was provided, or to one or more quality evaluators other than user 232, etc.

The feedback 240 is used to update a proprietary reward model 242 (or other generative AI model feedback mechanism or structure), which subsequently is used to fine tune (244) the proprietary model 236 that was used to generate the result 238. In this way, the developer of the application the user 232 used to create and submit the prompt 234 is able to obtain and benefit exclusively from the feedback 240, in some embodiments without have to write code to solicit the feedback 240, and with assurance that the feedback 240 from its user 232 will inure only to the benefit of the developer, and not their competitor(s) and/or the owner and other users of the foundational model on which the proprietary model 236 is based.

FIG. 2C is a diagram illustrating the creation and maintenance, in various embodiments, of a proprietary generative AI model as disclosed herein. In the example shown, diagram 260 shows version 1.0 of a foundational or other base model 262 being created at a first time. At a subsequent time, version 1.0 or a proprietary model 268 is created based on the foundational/base model 262. The foundational/base model 262 subsequently continues to be improved/update, to create versions 1.1 and 1.2 (reference numbers 264, 266) in this example. Such updates (264, 266) are not reflected in the proprietary model 268. However, feedback solicited from users based on content generated using the proprietary model 268 is processed, in this example to train reward models 270, 272, which in turn are used to fine tune the proprietary model 268, in successive and/or continuous or ongoing operations, to produce successively fine-tuned versions 274, 276 of the proprietary model 268.

Later, a new version 2.0 of the foundational model 278 is released. The new version 2.0 of the foundational model 278 may include/reflect documents, images, or other content creating after the creation of version 1.0 of the foundational model 262.

In various embodiments, an application owner/developer, or other owner of the exclusive right to use a proprietary model, such as the proprietary model 268, 274, 276 shown in FIG. 2C may wish to generate and use a proprietary model 282 based on the version 2.0 of the foundational model 278. In various embodiments, the reward model 270, 272 used to fine-tune the proprietary model 268, 274, 276 based on version 1.0 of the foundational model 262 may be used, e.g., via cloned copy 277 of reward model 1.1 in this example, to fine tune the base/foundational model 278 to provide proprietary model 282 and/or to provide and/or train a reward model 284 to be used to fine-tune the proprietary model 282 created based on version 2.0 of the foundational model 278, to produce a fine-tuned proprietary model 286 that is derived from version 2.0 of the foundational model 278 and also incorporates improvements based on the user feedback embodied and/or reflected in the reward models 270, 272 generated based on explicit (thumbs up or thumbs down, scale or one to ten, etc.) or implicit (which of n options selected for use) user feedback with respect to content generated using the proprietary models 268, 274, 276 derived from version 1.0 of the foundational model 262.

While in the example shown in FIG. 2C the reward model 270, 272, 277, 284 is used to fine tune a single private model derived from a base model, in various embodiments a single reward model may be applied to fine tune one or more other private models, such as other models associated with a same user or application, etc.

While in the example shown in FIG. 2C a reward model based on human feedback is described, in other embodiments other mechanisms to receive and fine tune a generative AI model based on feedback on content generated using the generative AI model may be used.

As shown in FIG. 2C, version 2.0 of the foundational model 278 may be further fine-tuned, e.g., to produce a fine-tuned model 280, and so on, and eventually a version 3.0 of the foundational model may be generated, etc. In various embodiments, techniques disclosed herein may be applied upon each subsequent release of a new version of the foundational model, to update the proprietary model to reflect changes to the foundational model, while still benefiting from the accumulated learning based on user feedback embodied in the private reward models, e.g., 270, 272, and 284.

While in the example described above the “version 2.0” model 278 is a subsequent version of version 1.0 model 262, in other embodiments and examples the model 278 may be subsequent base or foundation version of the same model 262. For example, model 278 may be generated in a different way and/or based on a different corpus of input data than model 262.

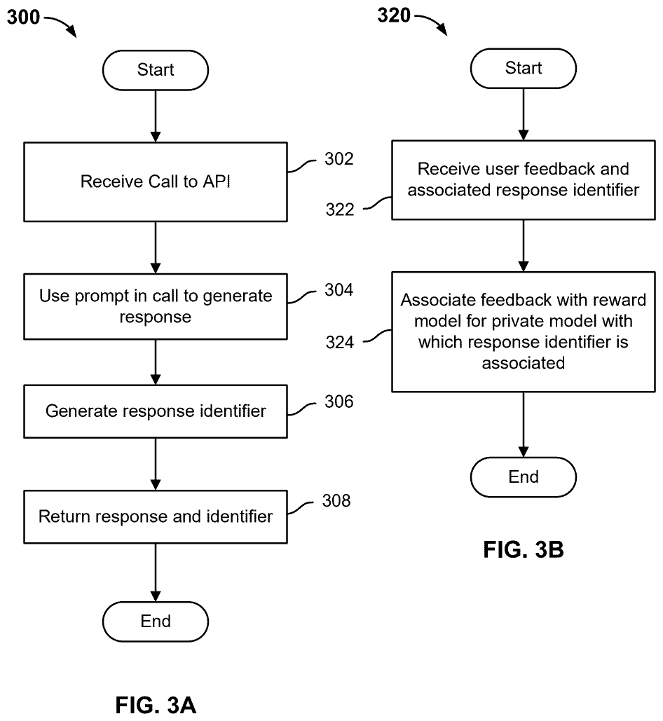

FIG. 3A is a flow diagram illustrating an embodiment of a process to respond to a generative AI system prompt received from a user associated with a proprietary model. In various embodiments, process 300 of FIG. 3A may be performed by a generative AI system, such as generative AI service 110 of FIG. 1. In the example shown, at 302, an API call is received at a generative AI system to generate content using a proprietary model. For example, the call may be received from an application server or other device with which the proprietary model is associated. At 304, a prompt included in the API call received at 302 and the proprietary model with which it is associated are used to generate a response. At 306, a response identifier associated (uniquely) with the response generated at 304 is generated. At 308, the responsive content generated at 304 and the response identifier generated at 306 are returned to the sender from which the API call received at 302 was received. In various embodiments, the response and identifier returned at 308 may include and/or be associated with a widget or other interface displayed to a user to solicit feedback from the user on the quality of the response generated at 304.

FIG. 3B is a flow diagram illustrating an embodiment of a process to receive and use feedback provided to a generative AI system in response to content generated using a proprietary model. In various embodiments, process 320 of FIG. 3B may be performed by a generative AI system, such as generative AI service 110 of FIG. 1. In the example shown, at 322 a communication is received that includes an indication of user feedback on AI-generated content provided to the user and the response identifier with which the AI-generated content to which the feedback pertains is associated. At 324, the feedback received at 322 is associated with a reward model that is associated with a proprietary model with which the response identifier included with the feedback received at 322 is associated. The reward model subsequently is used to fine tune the proprietary model.

While in the example shown in FIGS. 3A and 3B and described above a response identifier is generated and used to associate an instance of user feedback with a proprietary model, in various embodiments one or more other techniques may be used to associate an instance of user feedback with a proprietary model used to generate content with which the feedback is associated. For example, in some embodiments, a timer is started when content generated using a proprietary model is provided, and feedback received within a prescribed time frame is associated with the proprietary model used to generate the content. In various other embodiments, one or more other and/or different techniques may be used to associate user feedback with a proprietary model used to generate the content to which the feedback is responsive.

While in various embodiments described above, a derived model with respect to which feedback is applied is characterized as a “private” or “proprietary” model, but in other embodiments the derived model may be publicly available or available for shared use by a group of users.

In various embodiments, techniques disclosed herein may be used to enable an application developer/owner to obtain and benefit from user feedback from their users, without having to write code to solicit the feedback and with assurance that the feedback from its users will inure only to the benefit of the developer, and not their competitor(s) and/or the owner and other users of the foundational LLM on which the proprietary model is based.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a communication interface; and
a processor coupled to the communication interface and configured to:
receive via the communication interface feedback associated with content generated by artificial intelligence in response to a prompt;
determine a private model with which the feedback is associated; and
use the feedback to update a reward model associated with the private model.

2. The system of claim 1, wherein the private model with which the feedback is associated is determined at least in part by determining that one or both of the prompt and the content generated by artificial intelligence in response to the prompt is associated with the private model.

3. The system of claim 1, wherein the private model comprises a subset of a plurality of models comprising an artificial intelligence system or service.

4. The system of claim 1, wherein the reward model is associated exclusively with the private model.

5. The system of claim 1, wherein the private model is based on a foundational model.

6. The system of claim 5, wherein the private model is trained at least in part on proprietary data on which the foundational model is not trained.

7. The system of claim 5, wherein the private model comprises a first private model included in a plurality of private models based on the foundational model.

8. The system of claim 7, wherein the reward model comprises a first reward model included in a plurality of reward models, each of which is associated with a corresponding subset of the plurality of private models.

9. The system of claim 8, wherein each reward model in the plurality of reward models is associated exclusively with a corresponding one of the plurality of private models.

10. The system of claim 1, wherein the feedback is associated with a user and the user is associated with an entity that has a proprietary or other exclusive interest in the private model.

11. The system of claim 10, wherein the entity comprises an enterprise or other group or association of individuals.

12. The system of claim 10, wherein the entity comprises one or more of an application, an application developer, an application owner, and an application provider, and wherein the user comprises a user of the application.

13. The system of claim 1, wherein the feedback comprises a score of other value reflecting a judgment of the relative quality of the content.

14. The system of claim 13, wherein the feedback is provided by a human user with whom the prompt is associated.

15. The system of claim 14, wherein the feedback is provided via a user interface provided by an artificial intelligence service provider which used the private model to generate the content in response to the prompt.

16. The system of claim 15, wherein the feedback is associated with one or both of the private model and the reward model based at least in part on a response identifier associated with one or both of the prompt and the content and wherein the response identifier is generated and provided by said artificial intelligence service provider.

17. The system of claim 1, wherein the private model is based on a foundational model and the processor is further configured to:
receive an indication that a new version of the foundational model has become available;
generate a new version of the private model based at least in part on the new version of the foundational model; and
use the reward model to fine tune the new version of the private model.

18. A method, comprising:
receiving via a communication interface feedback associated with content generated by artificial intelligence in response to a prompt;
using a processor to determine a private model with which the feedback is associated; and
using the processor to use the feedback to update a reward model associated with the private model.

19. The method of claim 18, wherein the private model comprises a subset of a plurality of models comprising an artificial intelligence system or service and the reward model is associated exclusively with private models included in the subset of the plurality of models comprising the artificial intelligence system or service.

20. A computer program product embodied in a non-transitory computer readable medium and comprising computer instructions for:
receiving via a communication interface feedback associated with content generated by artificial intelligence in response to a prompt;
determining a private model with which the feedback is associated; and
using the feedback to update a reward model associated with the private model.
